(19) United States
(12) Patent Application Publication
(10) Pub. No.: US 2007/0077911 A1
(43) Pub. Date: Apr. 5, 2007

(54) Method and apparatus to facilitate transferring prepaid units between accounts

(75) Inventor: Sundar Raman, Chicago, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/242,760

(22) Filed: Oct. 4, 2005

(51) Int. Cl. H04M 11/00

(52) U.S. Cl. 455/405; 370/352

(57) ABSTRACT

At least one network element as comprises a part of a communication system maintains (11) a prepaid units account on behalf of each of a plurality of communication system users, wherein the prepaid units correspond to at least one prepaid data communication service. Upon receiving (12) a message from a first communication system user authorizing a transfer of at least some portion of the first communication system user's prepaid units account to a second communication system uesr's prepaid units account, the network element(s) then preferably facilitates (13) a transfer of at least some portion of the first communication system user's prepaid units account to the second communication system user's prepaid units account.

### TECHNICAL FIELD

This invention relates generally to communication systems and more particularly to communication systems that provide prepaid communication services.

### BACKGROUND

Communication systems of various kinds are known in the art. Many such systems provide communication services to communication system users in exchange for some consideration (typically a monetary payment). In some cases the user pays for their respective usage in a retroactive manner. In other cases the user makes a prepayment in anticipation of such usage. A communication system that supports such prepaid services will typically maintain a prepaid units account on behalf of each such prepaid communication system user. Such a prepaid units account will typically correspond to at least one prepaid communication service such as, for example, a voice communication service.

Interest exists in being able to move such prepaid units from one account to another. Such interest can be particularly keen in settings where the prepaid units have a finite lifetime and will consequently expire unless used by some point in time. Present solutions, however, leave much to be desired. Present approaches, for example, are limited to rather inconvenient and clumsy interaction with a Signaling System 7-based infrastructure. Perhaps more importantly such approaches appear to be limited to prepaid voice services. As a result, for example, prepaid units as correspond to data communication services typically remain non-transferable from one user account to another via any user-friendly mechanism.

### BRIEF DESCRIPTION OF THE DRAWINGS

The above needs are at least partially met through provision of the method and apparatus to facilitate transferring prepaid units between accounts described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention;

FIG. 4 comprises a signal flow diagram as configured in accordance with various embodiments of the invention; and

FIG. 5 comprises a signal flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, at least one network element as comprises a part of a communication system maintains a prepaid units account on behalf of each of a plurality of communication system users, wherein the prepaid units correspond to at least one prepaid data communication service. Upon receiving a message from a first communication system user authorizing a transfer of at least some portion of the first communication system user's prepaid units account to a second communication system uesr's prepaid units account, the network element(s) then preferably facilitates a transfer of at least some portion of the first communication system user's prepaid units account to the second communication system user's prepaid units account.

In a preferred approach the aforementioned message comprises a relatively small, short message and may contain, depending upon the needs of the application setting, one or more of a mobile node identifier for the first communication system user and/or the second communication user and/or a number of prepaid units to be so transferred. Depending also on system needs, requirements, and/or preferences, the aforementioned facilitation can comprise transmitting a message to the second communication system user to indicate the amount by which the latter's prepaid units account is to be increased. The requested transfer can then be effected if and when the second communication system user responds with a response such as an acceptance message.

So configured, a communication system can now readily support and facilitate the user-driven transfer of prepaid units from one account to another. These teachings impose little burden on the resources of such a system and are further suitable for deployment in a non-SS7 context. These teachings also permit useful information regarding the pending and/or completed process to be provided to the authorizing party and/or the recipient beyond that which prior practice typically anticipates or practices.

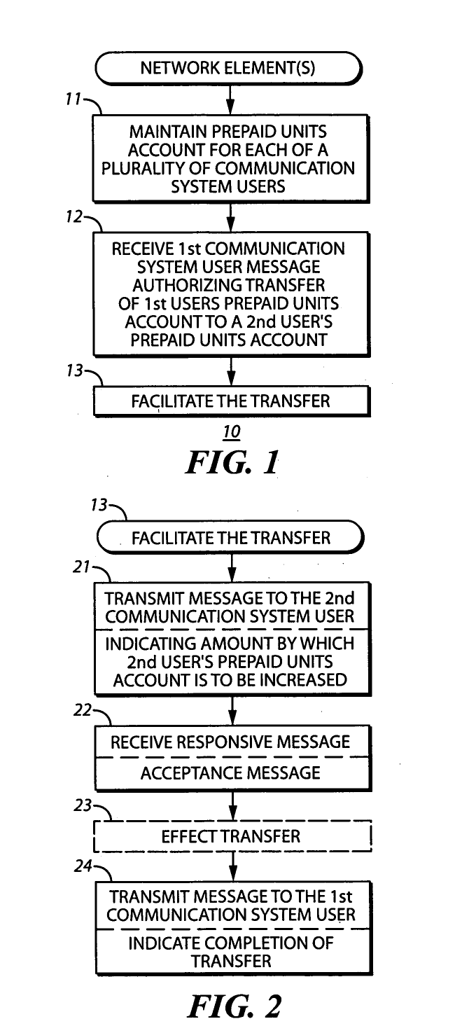

These and other benefits may become clearer upon making a thorough review and study of the following detailed description. Referring now to the drawings, and in particular to FIG. 1, an exemplary process 10 that may be effected via at least one network element (such as, but not limited to, a packet data serving node as is known in the art) as comprises a part of a communication system (such as, but not limited to, a code division multiple access wireless system as is known in the art) serves, in part, to maintain 11 a prepaid unit account on behalf of each of a plurality of communication system users. In a preferred embodiment these prepaid units correspond to at least one prepaid data communication service such as, but not limited to, an Internet Protocol-based prepaid data communication service. (Other data-bearing services could of course be employed if desired, such as, but not limited to, Asynchronous Transfer Mode (ATM), Frame-Relay, X.25, and so forth. In general, however, these protocols tend to converge to the Internet Protocol due to efficiency, scalability, and other related benefits.) As these teachings are not particularly sensitive to the selection of any particular account management scheme, and further as such accounts are generally otherwise known in the art, no further elaboration regarding the specifics of such accounts will be provided here for the sake of brevity.

When the network element (or elements) then receive 12 a message from a first communication system user that authorizes a transfer of at least some portion of the first communication system user's prepaid units account to a second communication system user's prepaid units account, this process 10 then provides for a responsive facilitation 13 of that transfer. The message itself may comprise any message as may be compatibly provided to the network element(s).

In a preferred approach, however, the message will comprise a relatively small message. Depending upon the available communication protocols suitable messages may be sent using, for example, Short Message Service messages, Short Data Burst messages, or Data Over Signaling messages as are all well known and understood in the art. Other examples are certainly possible and future developments will no doubt provide other suitable options as well.

The message may contain such information as may serve these intended purposes. For example, such a message may contain one or more of:
a mobile node identifier of the first communication system user;
a mobile node identifier of the second communication system user;
a number of the prepaid units to be transferred to the second communication system user's prepaid units account;
   to provide but a few examples. In the above examples, those skilled in the art will recognize and understand that the referred-to identifiers may be actual identifiers (such as, for example, a Network Access Identifier, a Uniform Resource Identifier, and so forth) or may be aliases that serve for some purpose in lieu of an actual identifier.

So configured, this process 10 permits a network element(s) to receive a message from a given communication system user that authorizes a transfer of prepaid units from a first account to the account of another communication system user and to respond accordingly. The precise nature of such facilitation 13 can, of course, vary with the specific needs and/or capabilities of a given application setting. Referring now, however, to FIG. 2, a specific illustrative example will be provided.

In this illustrative example, such facilitation 13 may comprise the network element(s) transmitting 21 a message to the second communication system user. In a preferred approach this transmission 13 occurs substantially immediately following receipt of the above-mentioned message from the first communication system user. Also in a preferred approach this message comprises a message that indicates the amount by which the second communication system user's prepaid units account is to be increased by the requested transfer. This can comprise, for example, a statement of the number of units themselves, an indication of the monetary value of the units to be transferred, an indication of the amount of services as correspond to the units to be transferred, and so forth as may be desired. (In an optional approach, the network element(s) can source a first message to the second communication system user (such as, for example, a simple invitation to respond). Upon then receiving a corresponding response as sourced from the second communication system user, the network element(s) can then respond with a message as is described above.)

Upon then receiving 22 a responsive message from the second communication system user (which responsive message may comprise, for example, an acceptance message indicating a willingness to receive the proffered transfer of prepaid units), this process then continues, preferably, with an effectuation 23 of the transfer. So configured, the authorized prepaid units will now be transferred from the prepaid units account of the first communication system user to the prepaid units account of the second communication system user. This, in turn, would typically mean that the second communication system user could then make immediate use of those prepaid units. (If desired, of course, a waiting period could be imposed with respect to such usage.)

In a preferred approach, this process will then further provide for transmitting 24 a message to the first communication system user to indicate completion of the transfer. Such a message can be as brief, or as complete and informative, as may be desired and/or as may comport with the needs and/or limitations of a given application setting.

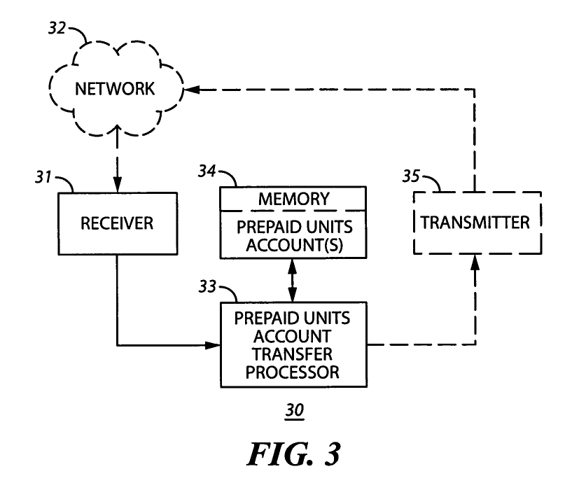

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative embodiment, a network element 30 comprises, in part, a receiver 31 that compatibly interacts with a network 32 of choice (such as, for example, an intranet or an extranet (such as the Internet)). This receiver 31 operably couples to a prepaid units account transfer processor 33 which couples, in turn, to a memory 34 that has prepaid units accounts stored therein for each of a plurality of communication system users and as are otherwise described above. In this illustrative embodiment these prepaid units accounts correspond to at least one prepaid Internet Protocol-based data communication service.

So configured, the receiver 31 can receive a message (via the network 32) from a first communication system user (not shown) which message comprises, for example, a request to transfer a specified number of prepaid units from the first communication system user's prepaid units account to a second communication system user's prepaid units account. In a preferred approach this message may identify both the first and the second communication system users by presenting corresponding mobile node identifiers for each party as described above.

The prepaid units account transfer processor 33 is preferably configured and arranged (via, for example, appropriate programming) to respond to the reception of such a message by the receiver by facilitating the requested transfer of prepaid units. As described above, this facilitating can optionally but preferably comprise causing the transmission of a message to the second communication system user which message indicates the amount by which the latter's prepaid units account is to be increased. Upon receiving an acceptance message from the second communication system user, in a preferred approach, the proposed transfer is completed and a corresponding message then transmitted to at least the first communication system user. A transmitter 35 may be operably coupled between the prepaid units account transfer processor 33 and the network 32 (or another network (not shown) where appropriate) to facilitate and support such transmissions by the prepaid units account transfer processor 33.

Those skilled in the art will recognize and understand that such an apparatus 30 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

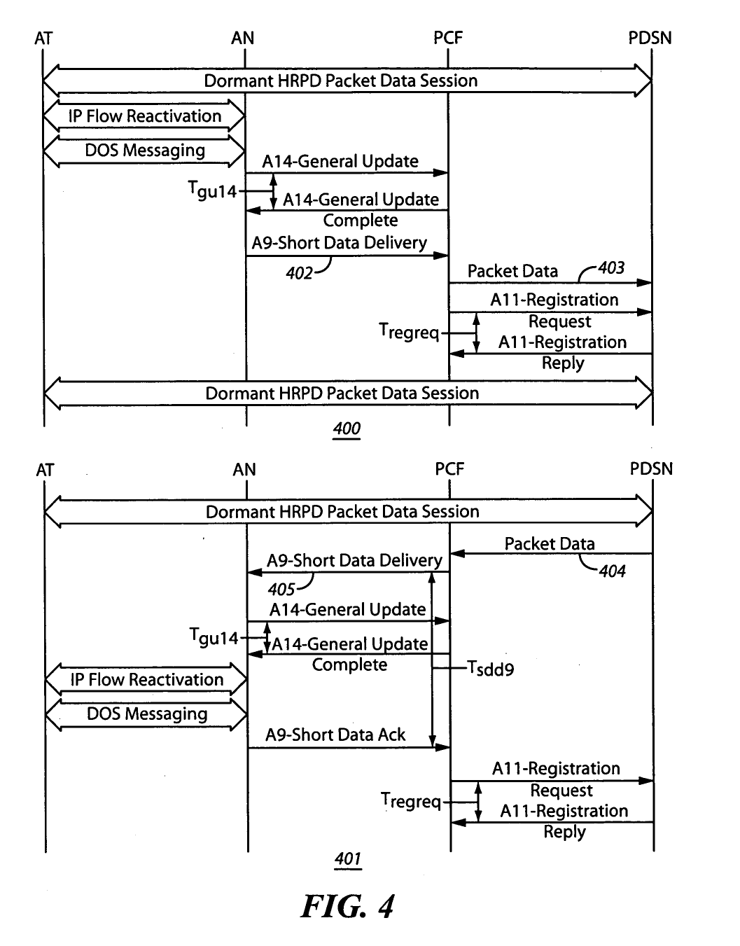

Referring now to FIG. 4, a more specific illustrative example will be provided with respect to illustrative signal flow diagrams. FIG. 4 presents a first and second signal flow diagram 400 and 401, where both signal flow diagrams 400 and 401 present Data Over Signaling messages (as specified in this instance by the CDMA2000 focused 3GPP2 standards body) within the context of a High Rate Packet Data (HRPD) session as is known in the art. In the first signal flow diagram 400, an Access Terminal (AT) such as a mobile node seeks to effect an account balance transfer as described above (which intent is communicated, for example, using Data Over Signaling messaging as illustrated). Within the context and exchange of a variety of regular and expected Date Over Signaling messages as illustrated, the Access Network (AN) of choice transmits an A9-short data delivery message 402 to the Packet Control Function (PCF) expressing the request of the Access Terminal to make the transfer. The latter then transmits a corresponding packet data message 403 to the Packet Data Serving Node (PDSN) which serves in this embodiment to effect the transfer process described above.

The second signal flow diagram 401 then illustrates, again within the context of Data Over Signaling messages, that the Packet Data Signaling Node can communicate with either the originating Access Terminal or with the target Access Terminal (i.e., the Access Terminal as corresponds to the account to which the account balance transfer is to be made) by sourcing a corresponding Packet Data message 404 to the Packet Control Function which then, in turn, can forward the substantive transfer-related content of that message via another A9-Short Data Delivery message 405 for eventual delivery to the intended Access Terminal via a Data Over Signaling message.

Those skilled in the art will see and appreciate that these teachings present little burden to the resources of a given network while nevertheless providing a relatively thorough and efficacious process for facilitating the transfer of credits from one user account to another.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method comprising:
at least one network element as comprises a part of a communication system:
maintaining a prepaid units account on behalf of each of a first communication system user and a second communication system user, wherein the prepaid units correspond to at least one prepaid data communication service;
receiving a message from the first communication system user authorizing a transfer of at least some portion of the first communication system user's prepaid units account to the second communication system user's prepaid units account;
facilitating the transfer of at least some portion of the first communication system user's prepaid units account to the second communication system user's prepaid units account.

2. The method of claim 1 wherein the prepaid data communication service comprises an Internet Protocol-based prepaid data communication service.

3. The method of claim 1 wherein receiving a message comprises receiving a Short Message Service message.

4. The method of claim 1 wherein receiving a message comprises receiving a Short Data Burst message.

5. The method of claim 1 wherein receiving a message comprises receiving a Data Over Signaling message.

6. The method of claim 1 wherein receiving a message comprises receiving a message that at least contains:
a mobile node identifier of the first communication system user;
a mobile node identifier of the second communication system user;
a number of the prepaid units to be transferred to the second communication system user's prepaid units account.

7. The method of claim 1 wherein facilitating the transfer comprises transmitting a message to the second communication system user.

8. The method of claim 7 wherein transmitting a message to the second communication system user comprises transmitting a message to the second communication system user indicating an amount by which the second communication system user's prepaid units account is to be increased.

9. The method of claim 8 wherein facilitating the transfer further comprises receiving a responsive message from the second communication system user.

10. The method of claim 9 wherein the responsive message comprises an acceptance message.

11. The method of claim 10 wherein facilitating the transfer further comprises, in response to receiving the acceptance message, transmitting a message to the first communication system user to indicate completion of the transfer.

12. The method of claim 8 wherein transmitting a message to the second communication system user further comprises substantially immediately transmitting the message to the second communication system user.

13. The method of claim 8 wherein transmitting a message to the second communication system user further comprises transmitting the message to the second communication system user in response to a message sourced by the second communication system user.

14. An apparatus comprising:
a memory having a prepaid units account on behalf of each of a first communication system user and a second communication system user stored therein, wherein the prepaid units correspond to at least one prepaid data communication service;
a receiver;
a prepaid units account transfer processor that is operably coupled to the memory and to the receiver and that is configured and arranged to respond to reception by the receiver of a message from the first communication system user authorizing a transfer of at least some portion of the first communication system user's prepaid units account to the second communication system user's prepaid units account by facilitating the transfer of at least some portion of the first communication system user's prepaid units account to the second communication system user's prepaid units account.

15. The apparatus of claim 14 wherein the prepaid data communication service comprises an Internet Protocol-based prepaid data communication service.

16. The apparatus of claim 14 wherein the message from the first communication system user comprises a Short Message Service message.

17. The apparatus of claim 14 wherein the message from the first communication system user comprises a Short Data Burst message.

18. The apparatus of claim 1 wherein the message from the first communication system user comprises a Data Over Signaling message.

19. The apparatus of claim 14 wherein the message from the first communication system user comprises a message that at least contains:
a mobile node identifier of the first communication system user;
a mobile node identifier of the second communication system user;
a number of the prepaid units to be transferred to the second communication system user's prepaid units account.

20. The apparatus of claim 14 further comprising a transmitter that is operably coupled to the prepaid units account transfer processor and wherein the prepaid units account transfer processor is further configured and arranged to facilitate the transfer by transmitting a message to the second communication system user.

21. The apparatus of claim 20 wherein the message to the second communication system user comprises a message indicating an amount by which the second communication system user's prepaid units account is to be increased.

22. The apparatus of claim 14 wherein the prepaid units account transfer processor comprises means for facilitating the transfer of at least some portion of the first communication system user's prepaid units account to the second communication system user's prepaid units account.

23. The apparatus of claim 22 wherein the prepaid units account transfer processor further comprises means for transmitting a message to the second communication system user indicating an amount by which the second communication system user's prepaid units account is to be increased.

24. The apparatus of claim 22 wherein the prepaid units account transfer processor further comprises means for responding to reception of an acceptance message from the second communication system user by facilitating transmitting a message to the first communication system user to indicate completion of the transfer.
